(19) United States
(12) Patent Application Publication
(10) Pub. No.: US 2010/0015415 A1
(43) Pub. Date: Jan. 21, 2010

(54) Individual user identification system and appliance for a towel

(76) Inventors: Cindy Hurst, Vancouver, WA (US); Tom Hurst, Vancouver, WA (US)

Correspondence Address: ATER WYNNE LLP, 1331 NW Lovejoy St. Suite 900, PORTLAND, OR, 97209-2785, US

(21) Appl. No.: 12/460,544

(22) Filed: Jul. 21, 2009

Related U.S. Application Data
(60) Provisional application No. 61/135,612, filed on Jul. 21, 2008.

(51) Int. Cl. B32B 3/06; G09F 3/08; G09F 3/18

(52) U.S. Cl. 428/195.1; 40/299.01; 40/642.02

(57) ABSTRACT

A towel user identification system or appliance includes one or more identification devices each configured to be removably affixed to a towel or the like, wherein each of the identification devices bears an individual-specific indicium on an outer surface thereof, and wherein each of the identification patches bears a first affixment means permanently attached on an inner surface thereof; and a second affixment means configured to be permanently attached to a towel or the like, the second affixment means configured further to removably capture one of the one or more identification devices thereto by cooperation of the first and second affixment means. Optionally, the system includes a stowing substrate configured to stow a plurality of the one or more identification devices in an array.

### RELATED APPLICATIONS

This application claims the benefit of priority to U.S. Provisional application No. 61/135,612, filed on 21 Jul. 2008 and entitled TOWEL USER IDENTIFICATION SYSTEM AND METHOD, the contents of which are hereby incorporated herein in their entirety by this reference.

### FIELD OF THE INVENTION

The invention relates generally to the field of current towel user marking and identification. More particularly, the invention relates to a system and method for marking towels in a common-use household or institutional setting to visually or otherwise associate a towel uniquely with its current individual user and to promote convenient and hygienic use thereof.

### BACKGROUND OF THE INVENTION

Towels are often reused by the same individuals multiple times between launderings. This is convenient but creates the possibility of inadvertent cross-use by different individuals and contamination or infection. In a household setting, various family members often cannot distinguish whose towel is whose, especially when matching towel sets are so common. In an institutional setting such as a resort, hotel, hostel, adult care or rehabilitation center, or the like, it can be even more difficult to identify a particular individual's towel since most institutional towels are identical. Laundering each towel after each use is often discouraged in an institutional setting because of environmental concerns, and at home it is impractical and costly to the environment and the budget.

### BRIEF DESCRIPTION OF THE DRAWINGS

FIG. 1 is an isometric view of a towel equipped with the towel user identification system in accordance with one embodiment of the invention.

FIG. 2 is a fragmentary side elevation of the identification system-equipped towel of FIG. 1 illustrating the affixing means that ensures durable, even washable, affixment between a towel and a unique user identification (ID) device.

FIG. 3 is a front elevation of an array of ID devices affixed to a substrate that can be used in a bathroom for deployment and use of one or more ID devices to identify the user of a towel or the like.

### DETAILED DESCRIPTION OF THE PREFERRED EMBODIMENTS

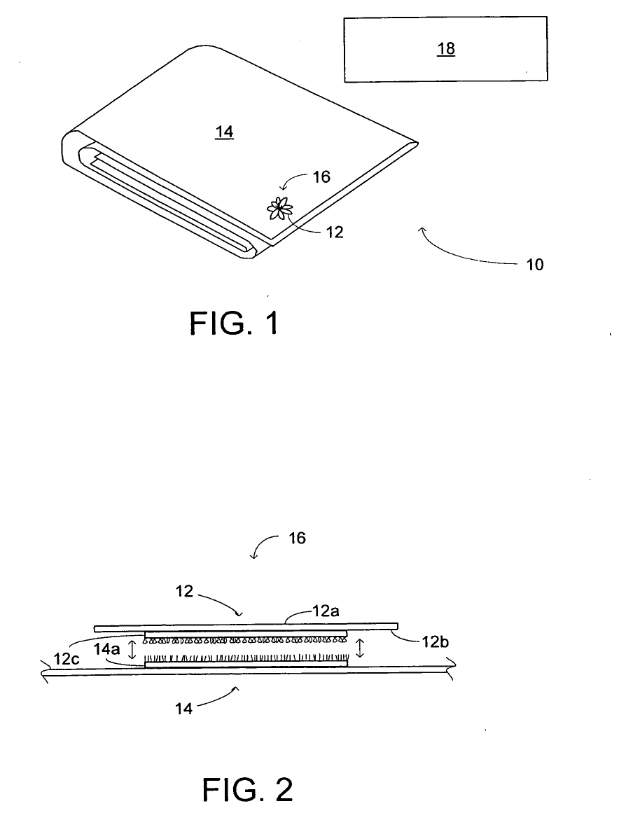

FIG. 1 is an isometric view of identification system 10 in accordance with one embodiment of the invention. Identification system 10 includes a unique ID device 12 (alternatively referred to herein as an identification element) affixable to a towel 14 or the like (e.g. a washcloth) subject to multiple use and preferably multiple use by the same individual user with whom the ID is associated. ID device 12 in accordance with one embodiment of the system includes on a first, exterior, visible surface 12a one or more indicia 16 of the user's identity, whether a unique color code, a unique pattern, a unique shape, a unique letter, a unique word, a unique graphic, or a simple monogram including one or more letters. ID device 12 in accordance with one embodiment of the system includes on a second, interior surface 12b first affixment means 12c for affixing the ID device 12 to towel 14 or the like. Towel 14 or the like includes on any exterior surface thereof a second, mating affixment means 14a for durably but removably and thus changeably affixing ID device 12 to towel 14 or the like.

In accordance with one embodiment of the invention, first affixment means 12c can take the form of a sewn or otherwise adhered patch of so-called loop fabric complementary to and operable with a sewn or otherwise adhered patch of so-called hook or pile fabric that can form a part of second affixment means 14a. Those of skill in the art will appreciate that first and second affixment means 12c and 14a thus cooperate in a so-called loop-and-pile (or hook-and-loop) configuration (available under the VELCRO™ brand) to durably but changeably affix ID device 12 to towel 14. Such durable affixment therebetween is designed to last in time at least between launderings of towel 14, and in accordance with one embodiment of the invention, even longer and at least also through the laundering process itself

ID device 12 can be uniquely shaped, as in the form of a flower or butterfly uniquely to identify an individual user, e.g. a particular family member. Or ID device 12 can be uniquely colored, as in a daughter's favorite soft pink, uniquely to identify an individual user. Or ID device 12 can be uniquely patterned, as in a son's favorite stripe or chevron pattern, uniquely to identify an individual user. Or ID device 12 can bear a unique graphic, as in a father's favorite papa bear character, uniquely to identify an individual user. Or ID device 12 can bear a letter, word or phrase, as in a mother's first name, a monogram containing her initials, or, simply, “MOM”, uniquely to identify an individual user. Or ID device 12 can bear a generic descriptor, as in a wife's or husband's “HERS” or “HIS”, uniquely to identify and distinguish between one of two individual users. Or ID device 12 can have a standard, e.g. circular, shape (and size) but nevertheless can bear such identifying indicia 16 that uniquely distinguishes each from every other. Those of skill in the art will appreciate that any suitable indicia on ID device 12 that is capable of identifying to the satisfaction of an individual and group of individuals an association with a particular individual currently using towel 14 is contemplated as being within the spirit and scope of the invention.

Indeed, indicia 16 that form a part of ID device 12 need not be visual at all, and certainly need not be visual only. For example, it may be alternatively or additionally tactile or olfactory, within the spirit and scope of the invention. Tactile indicia may include a tactilely identifiable texture or surface feature (e.g. a raised (embossed) or recessed (engraved) region that communicates to a sighted or even a blind and/or visually-impaired (B/VI) user the unique identity of the intended user of towel 14, wherein the B/VI user readily ‘reads’ the texture or surface feature by touch. Olfactory (e.g. scratch-and-sniff) indicia may include an identifiable fragrance that pleasantly communicates to a user the unique identity associated with the user of towel 14. Alternative means of indicating the unique identity of the intended user of towel 14 when ID device 12 is affixed thereto are possible. Additionally, some or all indicia for a given household can be symbolically or thematically associated with one another, e.g. a Papa Bear, A Mama Bear and various uniquely identifiable Baby Bears could be featured on the outer, visible surface of ID device 12. Thus, any and all such identifiable indicia are contemplated as being within the spirit and scope of the invention.

FIG. 2 illustrates in a fragmentary side elevation first and second affixment means 12c and 14a in operative relationship with one another. FIG. 2 is not to scale and the typical thicknesses of the various layers and densities of the loops and hooked piles (which for the sake of clarity in FIG. 2 lack their distal hooked ends) are intentionally scaled (exaggerated) up and down, respectively, for the sake of clarity. Those of skill in the art will appreciate that first affixment means 12c includes a region of pile texture that, in turn, includes densely juxtaposed hooked piles that extend between and thus interference-fit with, and thus adhere tightly and durably to, densely juxtaposed loops of a mating region of loop texture included in second affixment means 14a (this alternate mating and separating action is suggested by two double-ended arrows in FIG. 2). In accordance with one embedment of the invention, second affixment means 14a semi-permanently or permanently is formed in (e.g. by using new so-called “seamless” technologies), or is adhered or otherwise attached adjacent, one or more corners of towel 14, e.g. by weaving or sewing or adhering (as by a heat-curable adhesive such as that sold under the STITCH-WITCH™ brand. Two such curable adhesive layers are suggested by the broad lines in FIG. 2 between surface 12b and loop texture layer 12c and between hooked pile texture layer 14a and the adherable surface of towel 14).

Those of skill in the art will appreciate that mating loop and hook pile texture layers 12c and 14a and their adhesive layers can be substantially coextensive with the mating surface of ID device 12 for the strongest possible adherence. Alternatively, but within the spirit and scope of the invention, the loop and hook pile texture layers and their adhesive layers can be smaller in surface area, as suggested by FIG. 2, while still functioning to ensure durable affixment of the ID device to the towel or the like.

In accordance with one embodiment of the invention, ID device 12 is substantially smaller in surface area than is second affixment means 14a. This facilitates placement of ID device 12 onto affixment means 14a for effective affixment by providing what will be referred to herein as a larger ‘target’ area on towel 14. In one embodiment, for example, ID device 12 (and its corresponding first affixment means 12c) can be approximately 1 inch (1″) in diameter while second affixment means 14a can be approximately 3″ in diameter for an effective target area multiplier of approximately nine or ten. In another embodiment, ID device 12 and its corresponding first affixment means 12c can be approximately 1″ in diameter while second affixment means 14a can be approximately 3″ square for an effective target area multiplier of approximately eleven or twelve. Any such differential area between first and second affixment means 12c and 14a will be understood by those of skill in the art to greatly facilitate placement and affixment of ID device 12 on towel 14.

By utilizing the hook pile texture of the loop-and-pile (or loop-and-hook) fabric on the towel, those of skill will appreciate that the towel preserves its softness to a great extent even in the vicinity of second affixment means 14a. Utilizing the pile texture on the towel necessitates utilizing the loop texture on the ID device. Nevertheless, within the spirit and scope of the invention it is possible to swap the loop and hook pile texture regions such that the hook pile region is on the rear surface of ID device 12 and the loop region is on the front surface of towel 14. For example, the softer material, e.g. typically the hook pile textured fabric, is affixed to the towel because such is more comfortable in use and is approximately the same texture as terry cloth. All such interchangeable configurations of mating and cooperating affixment means are contemplated as being within the spirit and scope of the invention.

In accordance with one embodiment of the invention, the ID device 12 is of relatively small surface area, e.g. 1-2 inches in diameter or even less, and is relatively flat, e.g. ⅛ inch or less, so as to obtrude or impose only minimally on the functionality of towel 14 in normal use. Also in accordance with one embodiment of the invention, front surface 12a of ID device 12 is of a texture that is soft and pliant (and thus affixed-towel-compliant, e.g. materially similar to and conformable with a towel or the like) and preferably of a material and finish that is compatible with that of towel 14, e.g. typically so-called terrycloth. Nevertheless, any suitable size, material and finish is contemplated as being within the spirit and scope of the invention. For example, ID device 12 may feature a unique personal decor that involves handcrafting, e.g. tatting, petit-pointing, crocheting, needle-pointing, knitting, embroidering, beading, monogramming, or the like, to create a visual grace note that also functions as a unique identification of its designated user. Thus, indicia 16 can serve both utilitarian and aesthetic purposes.

In accordance with one embodiment of the invention, a monogram (broadly defined herein as including one or more letters perhaps representing one or more letters of a family member's initials) can be die cut or die stamped onto the outer surfaces of plural arrayed ones of device ID 12 thereby to form plural indicia 16 thereon in one semi-automated die-stamping operation. Such a die stamping process can greatly reduce labor costs and thus manufacturing costs. Alternatively, such a relatively inexpensive die stamping process can be used to effectively emboss or engrave distinctive, individual user-identifying indicia 16 onto the outer surface of device ID 12. Thus, any suitable automatic, semi-automatic, or manual process or method of imprinting device ID 12 with indicia 16 is contemplated as being within the spirit and scope of the invention.

In a household setting, a user makes device IDs having first affixment means and equips towels with the second affixment means. She or he does so by simply coming up with at least as many unique indicia 16a-16n for the front surface of the device IDs as there are n household users of towels, wherein n can be any integer number. Some of course can be one's favorite solid color, another can be a favorite printed or otherwise rendered stripe or other geometric design, another can bear a favorite cartoon character or mascot, yet another can have an identifying symbol, e.g. a heart or a ladybug or a T-ball team logo, still another can have an individual's initials or first name, etc. Each individual member of the household can choose one or more of their own personal indicia or one or more distinguishable indicia can be assigned by someone else.

Whichever member of the household does laundry can easily and quickly remove the device IDs from the towels and place them on the stowage substrate for later interchangeable placement on a clean towel. Or the launderer can wash the towels with the device IDs affixed thereto, thus obviating replacement on the clean towel while retaining the same favorite towel for an individual member's continuous use. Those of skill in the art will appreciate that the first and second affixment means are durable enough to withstand laundering intact. Those of skill in the art will also appreciate that the device IDs themselves are also durable enough to withstand laundering. Yet they are useful in accordance with the invention to identify to a individual household member the use over time of the same towel. Those of skill in the art will appreciate that this ensures hygiene among household members, since before using a towel, each user simply and regularly chooses the one that bears her or his unique indicia. Thus, it is possible flexibly and advantageously to employ the invented system in a household setting.

In an institutional setting (or the like), guests in a hotel suite or semi-private room of a care facility, for example, can unpack their collection of ID devices from their luggage and quickly and simply affix them to guest towels, effectively assigning a towel to each guest for the duration of her or his institutional stay. There is no room for confusion any more whose towel is whose, no matter how crowded with used or new towels the institutional room or suite's bathroom(s). Institutions can realize an advantage because the recommended re-use of towels no longer risks contagion or cross-contamination among guests and because labor costs and environmental impact are reduced. All the institution need do is contract or subcontract to have one corner of each towel equipped with a second affixment means so that there is an industry standard compatibility with industry standard first affixment means of sold and purchased ID devices. Such can be done during manufacture and before institutional purchase, or it can be done by retrofitting an existing inventory of guest towels. Such can be done with only nominal impact to the look and feel of the guest towels, as by placing the second affixment means within a region of the towel that causes the same to blend with, for example, the institution's own branding or labeling.

Towels or the like bearing the ID device can be handled, washed, folded and hung or stacked as before, since the ID device represents an unimposing but helpful addition thereto. Thus, there is no net burden on either institutional ‘housecleaning’ staff or private household members or persons with laundry duties. Of course, institutional guests must remember to remove their ID devices from their towels as they place them within the guest bathroom for laundering (and thus simply and quickly to personally ‘brand’ fresh clean towels as their own by affixing their individual and distinguishable ID devices thereto).

Those of skill in the art will appreciate that the invention thus provides a unique advantage over conventional towel monogramming, for example, since monograms are permanent and not interchangeable. Instead, the invention provides plural, interchangeable ID devices for plural corresponding towels associated with plural corresponding users, so that the plural corresponding users each can use a particular towel identifiable to that user until another towel is desired to replace the given towel. Meanwhile, all members of a household or guests in a hotel suite or semi-private care facility know whose used towel is whose and can avoid infection or other negative hygienic consequence of mixed use of towels in a group setting. Because the towel identification means in accordance with the invention is only semi-permanent and readily changed, great flexibility is possible. Nevertheless, extended use of a given towel by a given user in accordance with the identification means is possible due to the durability of the affixment means employed.

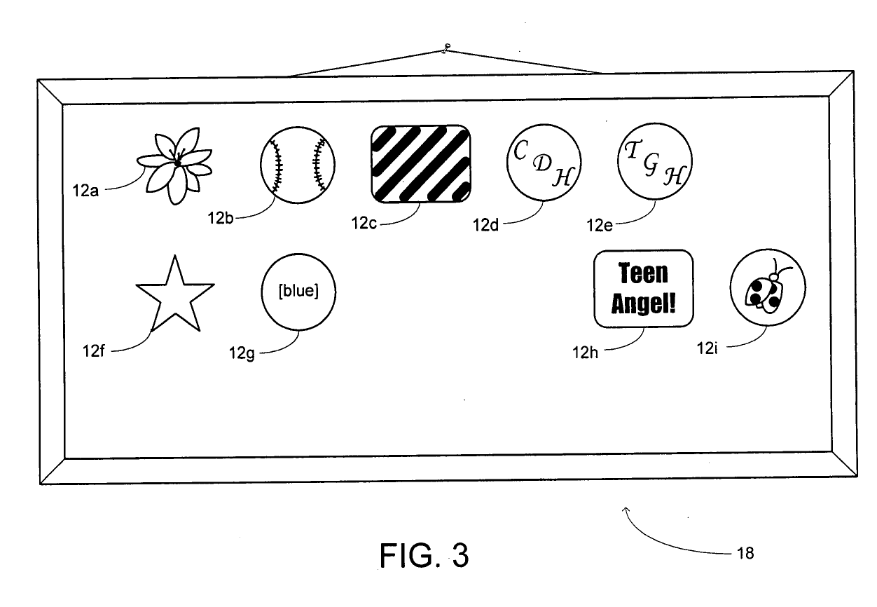

FIG. 3 is a front elevation of an array of ID devices affixed to a staging or stowing substrate 18 for easy deployment therefrom onto a towel or the like. Those of skill in the art will appreciate that substrate 18 can be hung on a bathroom (or laundry room) wall such that spare or currently unused ID devices are perpetually available in a convenient location near the towels with which they can be used. In accordance with one embodiment of the invention, substrate 18 takes the form of a hang-able framed ‘picture’ board the surface of which includes a large area of pile textile compatible with the loop textile of ID devices 16a-16i so that they may be easily and quickly adhered thereto or removed therefrom. Thus, system 10 in accordance with one embodiment further includes a storage substrate for arraying and displaying and deploying one or more ID devices thereon and therefrom. Those of skill in the art will appreciate that substrate 18 is dimensioned to array as many ID devices as is desired or necessary, depending upon the number of ID device in use within a household or hotel room or suite. Those of skill also will appreciate that an outer surface of substrate 18 is equipped in accordance with the invention with surface features like those of affixment means 14a, thereby to easily secure and remove ID devices thereon and therefrom.

ID devices 12a-12i in FIG. 3 are illustrative of a few illustrative ones of the many possible indicia contemplated by the invention. Specifically, ID device 12a includes a shape-and-object indicia resembling a flower; ID device 12b includes a graphic-and-theme indicia resembling a baseball; ID device 12c includes a lining-and-pattern indicia featuring diagonal stripes against a rounded rectangular shape, ID devices 12d and 12e include indicia featuring three-initial monograms against a round shape; ID device 12f includes indicia in the shape of a star; ID device 12g includes a simple (blue) color circular field without graphics or text; ID device 12h includes a word phrase such as a nickname or favorite song against a rounded rectangular shape; and ID device 12i includes a ladybug image within a circular shape.

These and myriad other combinations of shape, graphics, text, color, pattern, theme, favorite object, or other symbolic suggestion of ownership are contemplated as being within the spirit and scope of the invention, as mentioned above, and can be two-dimensional (relatively flat) or three-dimensional (e.g. they can have raised, embossed, engraved, recessed, relieved, etc. features) or otherwise distinguishable, e.g. by distinctive fragrance and/or texture, and/or other means.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

We claim:

1. A towel user identification system comprising:
one or more identification devices each configured to be removably affixed to a towel or the like,
wherein each of the identification devices bears an individual-specific indicium on an outer surface thereof, and wherein each of the identification patches bears a first affixment means permanently attached on an inner surface thereof; and
a second affixment means configured to be permanently attached to a towel or the like, the second affixment means configured further to removably capture one of the one or more identification devices thereto by cooperation of the first and second affixment means.

2. The system of claim 1, wherein each of the identification devices is configured to be flat and, when affixed to the towel or the like, unobtrusive.

3. The system of claim 1, wherein each individual-specific indicium includes a distinctive monogram, color, shape, or graphic visually identifiable to a specific individual.

4. The system of claim 1, wherein the first and second affixment means collectively include complementary loop-and-hook materials.

5. The system of claim 4, wherein the first affixment means includes a loop material and wherein the second affixment means includes a hook material.

6. The system of claim 1, wherein each individual-specific indicium includes a distinctive textured pattern tactilely identifiable to a specific individual.

7. The system of claim 1, wherein each user-specific indicium includes a distinctive fragrance olfactorily identifiable to a specific user.

8. The system of claim 1 which further comprises:
a stowing substrate configured to stow a plurality of the one or more identification devices in an array, an outer surface of the stowing substrate including an expanse of second affixment means compatible with the first affixment means of each of the plurality of devices, thereby to facilitate stowing of one or more of the plural devices when the one or more of the plural devices is not affixed to a towel or the like.

9. The system of claim 1, wherein each individual-specific indicium is an individual user's monogram.

10. The system of claim 9, wherein the each monogram is die-stamped into the outer surface of the corresponding patch.

11. The system of claim 1 further comprising:
a towel or the like including the second affixment means in a defined location thereon.

12. The system of claim 11, wherein the defined location is adjacent a corner of the towel or the like.

13. The system of claim 11, wherein one of the plurality of patches configured on a corresponding towel or the like collectively is washable without impairing either of the identification or affixment functions.

14. The system of claim 1, wherein each of the plurality of patches is washable without impairing either of the identification or affixment functions.

15. An individual user identification appliance for use with a towel or the like, the appliance comprising:
a cloth user identification element;
the cloth element including a first affixment means on an inner surface thereof and an indicium on an outer surface thereof, the indicium configured to identify the element to a specific individual user of a towel of the like; and
a second affixment means configured for permanent attachment to the towel or the like,
the first and second affixment means configured to cooperatively removably affix themselves to one another when pressed together.

16. The appliance of claim 15, wherein the indicium is visual.

17. The appliance of claim 16, wherein the indicium includes a distinctive monogram, color, shape, or graphic visually identifiable to a specific user.

18. The appliance of claim 15, wherein the indicium is tactile.

19. The appliance of claim 15, wherein the indicium is olfactory.

20. The appliance of claim 15, wherein the first and second affixment means collectively include complementary loop-and-hook materials.

21. The appliance of claim 20, wherein the first affixment means includes a loop material and wherein the second affixment means includes a hook material.

22. The appliance of claim 15, wherein the cloth element including the first affixment means and the indicium is flat and pliable, and wherein an outer surface of the cloth element and the indicium is soft.

23. The appliance of claim 15, wherein the indicium is an individual user's monogram.

24. The appliance of claim 23, wherein the monogram is die-stamped into the outer surface of the cloth element.

25. The appliance of claim 15, wherein the cloth element is dimensioned to be substantially smaller in two-dimensional extent than is the second affixment means, thereby to provide a relatively larger affixment target on a towel for the relatively smaller identification element.
